(19) United States
(12) Patent Application Publication
(10) Pub. No.: US 2020/0071976 A1
(43) Pub. Date: Mar. 5, 2020

(54) WINDOW, DOOR OR THE LIKE HAVING A SCISSOR ARM STAY BETWEEN A FIXED FRAME AND A LEAF

(71) Applicant: ROTO FRANK AG, Leinfelden-Echterdingen (DE)

(72) Inventors: Jinxuan Zhou, Stuttgart (DE); Kevin Bienert, Wendlingen (DE); Manuel Gonser, Kirchheim unter Teck (DE); Helmut Stauch, Steinenbronn (DE)

(73) Assignee: ROTO FRANK AG, Leinfelden-Echterdingen (DE)

(21) Appl. No.: 16/321,955

(22) PCT Filed: Aug. 5, 2016
(86) PCT No.: PCT/EP2016/068803

§ 371 Date: Jan. 30, 2019

(51) Int. Cl. E05D 15/30; E05D 15/32; E05F 5/00

(52) U.S. Cl. CPC E05D 15/30; E05D 15/32; E05Y 2900/132; E05Y 2900/148; E05F 5/00

(57) ABSTRACT

The invention relates to a window or door, having a fixed frame and a leaf which can be moved relative to the fixed frame and having a scissor arm stay between the fixed frame and the leaf.

The invention relates to a window, door or the like, having a fixed frame and a leaf which can be moved relative to the fixed frame and having a scissor arm stay between the fixed frame and the leaf,
wherein the scissor arm stay has a scissor arm which is supported, on the one hand, by means of a fixed-frame-side pivot bearing so as to be able to be pivoted about a fixed-frame-side pivot axis which extends parallel with a main plane of the fixed frame and which, on the other hand, is pivotably supported by means of a leaf-side pivot bearing about a leaf-side pivot axis which extends parallel with the fixed-frame-side pivot axis,
wherein, as a result of a movement of the leaf relative to the fixed frame, the fixed-frame-side pivot bearing can be moved perpendicularly to the fixed-frame-side pivot axis along the fixed frame and/or the leaf-side pivot bearing can be moved perpendicularly to the leaf-side pivot axis along the leaf,
wherein the fixed-frame-side pivot bearing is provided on a fixed-frame-side guiding piece which is provided as a guiding piece and/or the leaf-side pivot bearing is provided on a leaf-side guiding piece which is provided as a guiding piece,
wherein the fixed frame has, for the fixed-frame-side guiding piece, a guiding groove in the form of a fixed-frame-side guiding groove which is associated with the fixed-frame-side guiding piece and which extends with the longitudinal direction thereof in the movement direction of the fixed-frame-side pivot bearing along the fixed frame and/or the leaf has, for the leaf-side guiding piece, a guiding groove in the form of a leaf-side guiding groove which is associated with the leaf-side guiding piece and which extends with the longitudinal direction thereof in the movement direction of the leaf-side pivot bearing along the leaf,
wherein the guiding piece can be inserted into the guiding groove in an insertion direction which extends in the longitudinal direction of the associated guiding groove and the guiding piece which is inserted into the guiding groove is guided by means of the guiding groove in the movement direction of the relevant pivot bearing and is engaged over at a side remote from a groove base of the guiding groove by a groove wall of the guiding groove parallel with the groove base and can thereby be supported perpendicularly to the groove base and
wherein there is provided a braking element which is received in a receiving member of the guiding piece, which receiving member opens in the direction towards the groove base of the guiding groove, and which braking element can be positioned relative to the guiding piece with a positioning movement in a positioning direction of the braking element perpendicularly to the groove base and which can thereby be clamped between the guiding piece and the groove base.

Scissor arm stays of the above-mentioned type are commonplace as so-called “friction stay mechanisms”. By means of such a scissor arm stay a window leaf, for example, is provisionally secured in an opening position with respect to an associated fixed frame.

Generic prior art is disclosed in GB 2 081 803 A. This publication relates to a window having a scissor arm stay between a window leaf and a fixed window frame which scissor arm stay is constructed as a friction stay mechanism. Two of the arms of the scissor arm stay are in this instance pivotably articulated to a slider which itself is movably guided on a guiding rail along the main plane of the fixed window frame which guiding rail is connected to the fixed window frame. The guiding rail has a C-shaped cross-section and forms the groove wall of a guiding groove with a groove base and a groove opening which is opposite the groove base. Longitudinal edges of the groove opening are engaged behind by the slider which has been inserted into the guiding rail and thereby support the slider at the side remote from the groove base of the guiding groove. At the lower side facing the groove base, the slider is provided with a recess which opens in the direction towards the groove base and in which a plate-like braking element is loosely placed. By means of an adjustment screw which engages in a thread on the slider and which can be positioned perpendicularly to the groove base of the guiding groove, it is possible to vary the contact pressure of the braking element on the groove base and thereby the movement resistance with which the braking element counteracts the movements of the slider along the guiding rail which are connected with opening and closing movements of the window leaf.

When the slider and the braking element are mounted on the guiding rail, there is the risk that the braking element will become lost. If the slider is inadvertently mounted without the braking element and if, without knowledge of this circumstance, in order to adjust the braking action of the braking element the adjustment screw for the braking element is positioned in the direction towards the groove base of the guiding groove for the slider, there is produced a direct contact between the groove base of the guiding groove, on the one hand, and the tip of the adjustment screw, on the other hand. Movements of the window leaf relative to the fixed window frame and connected movements of the slider along the fixed-frame guiding rail lead in this instance to damage to the guiding rail.

An object of the present invention is to prevent assembly errors of the type described and potentially connected malfunctions of and damage to the relevant window, the relevant door or the like.

This object is achieved according to the invention by the window, door or the like according to patent claim 1.

In the case of the invention, a braking element by means of which, in the event of movements of the guiding piece which is provided with the braking element along the associated guiding groove, a braking action can be produced, is retained thereon in a non-detachable manner at least during the assembly of the guiding piece. In this instance, there is provided between the guiding piece and the braking element a component connection which, after assembly of the guiding piece and the braking element on the guiding groove, does not impair the ability to position the braking element relative to the guiding piece and consequently the ability to control the braking action which can be achieved by means of the braking element.

Specific embodiments of the window, door or the like according to patent claim 1 will be appreciated from the dependent patent claims 2 to 11.

In the case of the embodiment according to patent claim 2, the assembly of the guiding piece and the braking element on the associated guiding groove may require a deliberate handling of the braking element by the fitting installer. Only if the braking element is moved relative to the guiding piece into a position, in which the common cross-section of the guiding piece and the braking element is located within the cross-section of the guiding groove, can the guiding piece be introduced with the braking element in the insertion direction completely into the guiding groove. If a separate manoeuvre is required in order to overcome an overhang of the braking element with respect to the guiding piece outside the guiding groove, the possibility of inserting the guiding piece and the braking element completely into the guiding groove without handling the braking element signals to the fitting installer that the braking element is potentially missing on the guiding piece. As a result, the fitting installer is caused to verify whether the braking element is actually present and it is ensured that the guiding piece is not mounted without the braking element.

The overhang of the braking element with respect to the guiding piece, as a result of which the common cross-section of the guiding piece and the braking element has an excess dimension with respect to the cross-section of the associated guiding groove, is in a preferred embodiment of the invention during assembly of the guiding piece automatically overcome by the braking element being retained by means of the component connection on the guiding piece so as to be pivotable relative thereto about a pivot axis which extends perpendicularly relative to the insertion direction, and the receiving member which is provided on the guiding piece for the braking element being arranged in the insertion direction behind the component connection between the guiding piece and the braking element. The braking element, which is pivotably supported on the guiding piece about a pivot axis which extends perpendicularly to the insertion direction, is capable, when the guiding piece is inserted into the guiding groove, as a result of a connected action by the wall of the guiding groove, of independently carrying out a pivot movement with respect to the guiding piece and in this instance pivoting inwards into the receiving member provided for the braking element on the guiding piece. Such an automatic reduction of the common cross-section of the guiding piece and the braking element to the cross-section of the guiding groove is possible according to the invention since, during the assembly, the receiving member which is provided on the guiding piece for the braking element trails behind the component connection between the guiding piece and the braking element in the insertion direction. As a result of this feature of the invention, the receiving member provided on the guiding piece for the braking element is still located during the assembly at least partially outside the guiding groove when the component connection between the guiding piece and the braking element reaches the guiding groove. A continued insertion movement of the guiding piece then results in the braking element which is retained on the guiding piece by means of the component connection independently pivoting towards the region of the guiding piece in which the receiving member for the braking element is provided and which for the braking element consequently affords the possibility of reaching a pivot position in which the common cross-section of the guiding piece and the braking element is located within the cross-section of the guiding groove.

Generally, it is advantageous for the braking element to be pivotably supported by means of the component connection on the guiding piece. As a result of the pivotability, the braking element outside the guiding groove, may, for example during transport to the installation location under the action of a corresponding load, carry out an evasive movement without any fear of damage to the component connection.

Particularly for reasons of load-receiving capacity, the guiding piece in a preferred embodiment of the invention is constructed as a composite component having a metal carrier and a plastics material portion which is connected to the metal carrier, wherein, in particular for technical production reasons, the component connection between the guiding piece and the braking element is provided between the plastics material portion of the guiding piece and the braking element (patent claim 4).

According to patent claims 5 and 6, the metal carrier of the guiding piece which is constructed as a composite component is provided with a positioning device for positioning the braking element, wherein the positioning device on the metal carrier of the guiding piece is preferably constructed as a thread for an adjustment screw, by means of which the braking element can be positioned relative to the guiding piece. The forces which occur as a result of the clamping of the braking element between the groove base of the guiding groove and the guiding piece are consequently dissipated via the portion of the guiding piece which is more capable of bearing loads.

For corresponding reasons, in the case of the embodiment of the invention according to patent claim 7 there is provision for the guiding piece which is inserted into the guiding groove to be engaged over at the metal carrier by a groove wall of the guiding groove parallel with the groove base. Via the metal carrier, it is consequently possible to dissipate forces which act on the guiding piece as a result of the clamping of the brake element between the groove base of the guiding groove and the guiding piece into the groove wall of the guiding groove and via the groove wall into the fixed frame or leaf which is provided with the guiding groove.

According to patent claim 8, in a development of the invention the plastics material portion of the guiding piece which is constructed as a composite component takes over the guiding thereof in the associated guiding groove. With a corresponding material selection for the plastics material portion of the guiding piece, in particular a low-friction and low-wear guiding of the guiding piece in the guiding groove is thereby ensured.

Patent claim 9 relates to an embodiment of the invention which is preferred for manufacturing reasons. The guiding piece and the braking element are in this instance each at least partially constructed as an injection-moulded plastics material component and injection-moulded onto each other with the component connection being formed.

Also for manufacturing reasons, according to patent claim 10 the component connection between the guiding piece and the braking element is constructed as a film hinge.

In principle, it is possible according to the invention for the braking element to be permanently fixed to the guiding piece by means of the component connection. According to patent claim 11, however, it is also conceivable according to the invention for the component connection between the guiding piece and the braking element to last only until, after the assembly of the guiding piece and the braking element on the associated guiding groove, the braking element is positioned for the first time against the groove base of the guiding groove. An first positioning movement of the braking element with respect to the guiding piece brings about in the case of this embodiment of the invention a destruction of the component connection provided between the guiding piece and the braking element. As a result, an obstruction of the positioning movement of the braking element with respect to the guiding piece as a result of the component connection is excluded with certainty.

The invention is explained in greater detail below with reference to exemplary schematic illustrations in which:

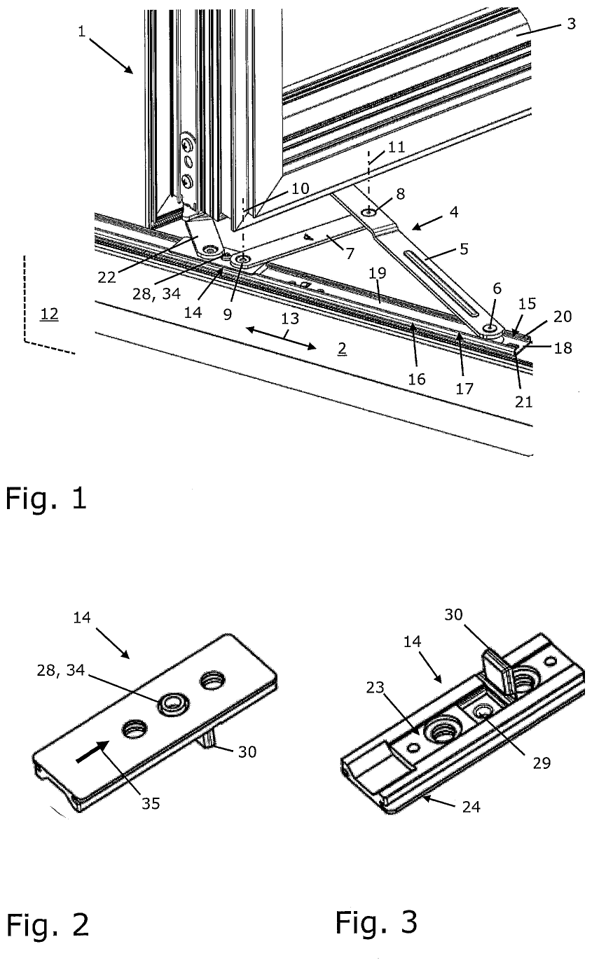

FIG. 1 is a partial illustration of a window having a fixed frame, a leaf and a friction stay mechanism which is provided between the fixed frame and the leaf as a scissor arm stay,

FIG. 2 is a perspective view from above of a guiding piece of the friction stay mechanism which guiding piece is arranged at the fixed frame side and provided with a braking element,

FIG. 3 shows the guiding piece with the braking element according to FIG. 2 as a perspective view of the lower side facing away from the viewer of FIG. 2,

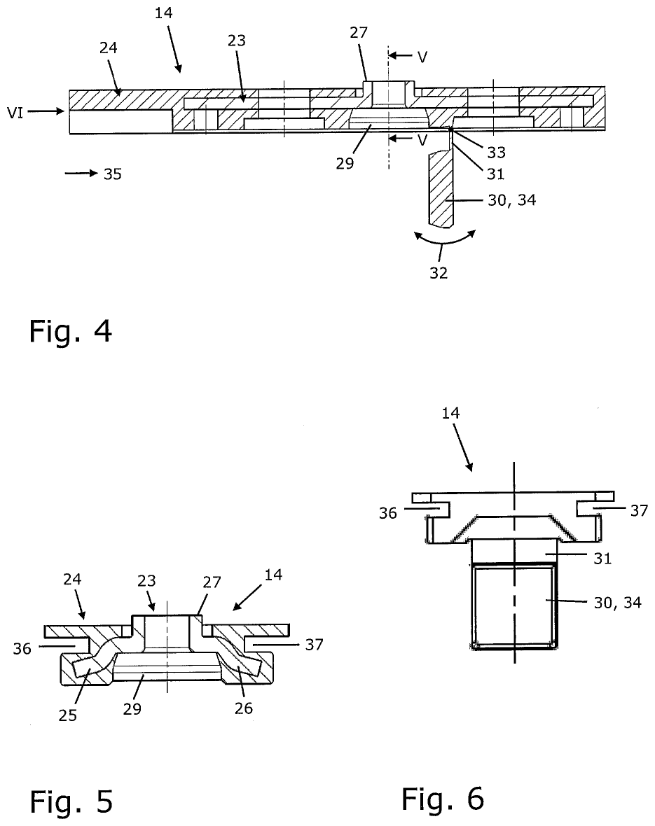

FIG. 4 is a longitudinal section of the guiding piece with the braking element according to FIGS. 2 and 3,

FIG. 5 is a cross-section of the guiding piece with a braking element according to FIGS. 2 to 4 in a plane of section extending in FIG. 4 along the line V-V, and

FIG. 6 shows the guiding piece with the braking element according to FIGS. 2 to 5 in the end-side view in the direction of the arrow VI in FIG. 4.

According to FIG. 1, a window 1 comprises a fixed frame 2 and a leaf 3 which opens outwards. A scissor arm stay which is arranged between the fixed frame 2 and the leaf 3 connects the leaf 3 to the fixed frame 2 and enables movements of the leaf 3 relative to the fixed frame 2 about a vertical rotation axis. A scissor arm stay which is structurally identical to the scissor arm stay illustrated in FIG. 1 is spaced apart from the scissor arm stay 4 along the leaf rotation axis and provided at the upper corner of the leaf 3 located outside the illustration cut-out of FIG. 1.

The scissor arm stay 4 comprises a stay arm 5 which is pivotably supported with one end on the fixed frame 2 and the other end on the leaf 3. The fixed-frame-side rotation axis and the leaf-side rotation axis of the stay arm 5 extend parallel with each other in a vertical direction. A fixed-frame-side pivot bearing 6 of the stay arm 5 cannot be changed in terms of position relative to the fixed frame 2. Accordingly, a leaf-side pivot bearing (which is concealed in FIG. 1) of the stay arm 5 is stationary relative to the leaf 3.

Between the fixed-frame-side pivot bearing 6 and the leaf-side pivot bearing of the stay arm 5, there is articulated to the stay arm 5 a scissor arm 7 of the scissor arm stay 4 by means of a leaf-side pivot bearing 8. At the opposing longitudinal end, the scissor arm 7 is pivotably supported on the fixed frame 2 by means of a fixed-frame-side pivot bearing 9. A fixed-frame-side pivot axis 10 which is formed by the fixed-frame-side pivot bearing 9 and a leaf-side pivot axis 11 of the scissor arm 7 which is formed by the leaf-side pivot bearing 8 also extend parallel with each other in a vertical direction. Both the pivot axes of the stay arm 5 and the pivot axes 10, 11 of the scissor arm 7 are consequently orientated parallel with a vertical main plane 12 of the fixed frame 2, which plane is indicated with broken lines in FIG. 1.

The fixed-frame-side pivot bearing 6 and the leaf-side pivot bearing of the stay arm 5 are, similarly to the leaf-side pivot bearing 8 and the fixed-frame-side pivot bearing 9 of the scissor arm 7, of conventional construction type. Bearing pins extend through corresponding bearing lugs on the components which are connected to each other in an articulated manner.

In contrast to the fixed-frame-side pivot bearing 6 of the stay arm 5, the fixed-frame-side pivot bearing 9 of the scissor arm 7 can move along the fixed frame 2. The movement direction of the fixed-frame-side pivot bearing 9 of the scissor arm 7 is indicated in FIG. 1 by a double-headed arrow 13.

In order to be able to carry out movements along the fixed frame 2, the fixed-frame-side pivot bearing 9 of the scissor arm 7 is provided on a guiding piece 14 which itself is guided by means of a fixed-frame-side guiding groove 15 in the movement direction 13 of the fixed-frame-side pivot bearing 9. The guiding groove 15 is delimited by a guiding rail 16 which is screwed to the fixed frame 2 and which forms a groove wall 17 of the guiding groove 15 which groove wall 17 is C-shaped in cross-section. The guiding groove 15 has a groove base 18 and a groove opening 19 which is opposite the groove base 18 and which extends in the movement direction 13 of the guiding piece 14. The groove opening 19 is delimited by mutually facing horizontal legs 20, 21 of the groove wall 17 which is C-shaped in cross-section.

With spacing from the scissor arm 7 on the guiding piece 14, a link 22 of the scissor stay arm 4 is pivotably supported by means of a corresponding pivot bearing. The opposing longitudinal end of the link 22 is supported on the leaf 3 so as to be able to be moved in a pivoting manner and in this instance cannot be changed in terms of position relative to the leaf 3. The pivot bearings of the link 22 also form pivot axes which extend parallel with each other in a vertical direction. When the leaf 3 is opened and closed, the link 22 guides in conventional manner the leaf 3 relative to the fixed frame 2 in such a manner that a collision of an overlapping leaf portion which is provided on the leaf 3 with the fixed frame 2 is prevented.

The guiding piece 14 which is guided in the fixed-frame-side guiding groove 15 in the movement direction 13 of the fixed-frame-side pivot bearing 9 is illustrated in detail in FIGS. 2 to 6, wherein these illustrations show the guiding piece 14 prior to assembly in the fixed-frame-side guiding groove 15.

The guiding piece 14 is a composite component with a metal carrier 23 and a plastics material portion 24. The plastics material portion 24 is injection-moulded onto the metal carrier 23 of the guiding piece 14.

According to FIG. 5, the metal carrier 23 of the guiding piece 14 has a substantially hat-shaped cross-section. With curved legs 25, 26, the metal carrier 23 extends almost over the entire length of the guiding piece 14. Substantially centrally, the metal carrier 23 forms a sleeve 27 which is provided with an inner thread which is not shown. The inner thread of the sleeve 27 receives an outer thread on an adjustment screw 28 which can be seen in FIGS. 1 and 2. Adjacent at both sides to the sleeve 27 of the metal carrier 23 are bearing lugs which receive the bearing pin of the fixed-frame-side pivot bearing 9 of the scissor arm 7 and the bearing pin of the fixed-frame-side pivot bearing of the link 22.

Below the sleeve 27, a receiving member 29 is recessed between the curved legs 25, 26 of the metal carrier 23 in the plastics portion 24 of the guiding piece 14. The receiving member 29 is intended for a brake pad 30 which is provided as a braking element. In the same manner as with the plastics material portion 24 of the guiding piece 14, the brake pad 30 is also a plastics material injection-moulded component. With a component connection 31 being formed, the brake pad 30 is injection-moulded on the plastics material portion 24 of the guiding piece 14.

As a result of corresponding material properties of the plastics material used for the plastics material portion 24 of the guiding piece 14, the brake pad 30 and the component connection 31, the component connection 31 permits pivot movements of the brake pad 30 relative to the guiding piece 14 in the direction of a double-headed arrow 32 illustrated in FIG. 4. At the beginning of the component connection 31 on the plastics material portion 24 of the guiding piece 14, a pivot axis 33 of the brake pad 30 which extends perpendicularly to the drawing plane of FIG. 4 is formed. The brake pad 30 is part of an adjustable friction brake 34 for the guiding piece 14 and consequently for the leaf 3 of the window 1.

During the assembly on the fixed-frame-side guiding rail 16, the guiding piece 14 must be inserted in an insertion direction 35 which extends perpendicularly to the pivot axis 33 of the brake pad 30 into the fixed-frame-side guiding groove 15. In this instance, the guiding piece 14 must be orientated in such a manner that, during the assembly movement, the receiving member 29, which is provided on the lower side of the guiding piece 14 for the brake pad 30, trails behind in the insertion direction 35 with respect to the component connection 31 which is provided between the guiding piece 14 and the brake pad 30. In order to prevent an incorrect orientation of the guiding piece 14 during assembly, in the plastics material portion 24 of the guiding piece 14 at the upper side thereof, an arrow which indicates the insertion direction 35 is formed (FIG. 2).

For introduction into the guiding groove 15, the guiding piece 14 must be positioned at the guiding groove 15 in such a manner that, during a movement of the guiding piece 14 in the insertion direction 35, the legs 20, 21 of the groove wall 17 of the guiding groove 15 enter longitudinal grooves 36, 37 which extend on the plastics material portion 24 of the guiding piece 14 over the entire length thereof and which reach in the transverse direction of the guiding piece 14 over the curved legs 25, 26 of the metal carrier 23 of the guiding piece 14 (FIG. 5).

In the initial state outside the guiding groove 15, the guiding piece 14 and the brake pad 30 which is retained by means of the component connection 31 on the guiding piece 14 have a common cross-section which as the perpendicular projection in the insertion direction 35 on the cross-section of the guiding groove 15 overhangs the cross-section of the guiding groove 15 since the brake pad 30 forms a projection with respect to the guiding piece 14. In order to eliminate the projection of the brake pad 30 with respect to the guiding piece 14 and thereby to reduce the common cross-section of the guiding piece 14 and the brake pad 30 in such a manner that it is located within the cross-section of the fixed-frame-side guiding groove 15, the brake pad 30 must be pivoted out of the position according to FIGS. 2, 4 and 6 about the pivot axis 22 towards the guiding piece 14 until the brake pad 30 comes to rest inside the receiving member 29 on the guiding piece 14. If the brake pad 30 is pivoted into the receiving member 29 on the guiding piece 14, the guiding piece 14 can be introduced over the entire length thereof in the insertion direction 35 into the guiding groove 15.

The fitter can pivot the brake pad 30 with a corresponding operation into the receiving member 29 on the guiding piece 14 and can subsequently insert the guiding piece 14 together with the brake pad 30 completely into the guiding groove 15. If the fitter intentionally or inadvertently omits the pivoting of the brake pad 30 into the receiving member 29 on the guiding piece 14, when the guiding piece 14 is inserted into the guiding groove 15 in the insertion direction 35 the component connection 31 strikes the end face of the groove wall 17 of the guiding groove 15 and a continued movement of the guiding piece 14 in the insertion direction 35 results in the brake pad 30 independently and without any risk of being violently separated from the guiding piece being redirected from the position according to FIG. 4 in the direction towards the receiving member 29 and finally being introduced in the receiving member 29 on the guiding piece 14. Consequently, the brake pad 30 then assumes a position in which the common cross-section of the guiding piece 14 and the brake pad 30 is located within the cross-section of the guiding groove 15 and in which consequently a complete introduction of the guiding piece 14 into the guiding groove 15 is possible.

The brake pad 30 is used to produce a movement resistance for the movement of the guiding piece 14 which is mounted on the guiding groove 15 and of the fixed-frame-side pivot bearing 9 which is provided on the guiding piece 14, when the guiding piece 14 performs a movement along the fixed frame 2, which movement is linked with an opening or closing movement of the leaf 3, wherein, as a result of the movement resistance, the leaf 3 only leaves a current pivot position when a sufficiently large force acts on the leaf 3 in the opening or closing direction.

The adjustment screw 28 which engages with the outer thread thereof in the inner thread on the sleeve 27 of the metal carrier 23 of the guiding piece 14 is used to control the movement resistance produced by means of the brake pad 30. By means of corresponding rotational actuation of the adjustment screw 28, the brake pad 30 can be clamped to a greater or lesser extent between the groove base 18 of the fixed-frame-side guiding groove 15 and the guiding piece 14 which is engaged over by the legs 20, 21 of the groove wall 17 parallel with the groove base 18. Forces which occur as a result of the clamping of the brake pad 30 between the guiding piece 14 and the groove base 18 of the guiding groove 15 are dissipated via the guiding piece 14 and the groove wall 17 of the guiding groove 15 into the fixed frame 2. In this instance, it is advantageous for the metal carrier 23 of the guiding piece 14, which carrier is sufficiently capable of bearing loads, to be included in the force path. An undesirable deformation of the guiding piece 14 under the action of the forces which occur is thereby prevented.

1. A window or door, having a fixed frame (2) and a leaf (3) which can be moved relative to the fixed frame (2) and having a scissor arm stay(4) between the fixed frame (2) and the leaf (3),
wherein the scissor arm stay (4) has a scissor arm (7) which is supported, on the one hand, by means of a fixed-frame-side pivot bearing (9) so as to be able to be pivoted about a fixed-frame-side pivot axis (10) which extends parallel with a main plane (12) of the fixed frame (2) and which is pivotably supported by means of a leaf-side pivot bearing (8) about a leaf-side pivot axis (11) which extends parallel with the fixed-frame-side pivot axis (10),
wherein, as a result of a movement of the leaf (3) relative to the fixed frame (2), the fixed-frame-side pivot bearing (9) can be moved perpendicularly to the fixed-frame-side pivot axis (10) along the fixed frame (2) and/or the leaf-side pivot bearing (8) can be moved perpendicularly to the leaf-side pivot axis (11) along the leaf (3),
wherein the fixed-frame-side pivot bearing (9) is provided on a fixed-frame-side guiding piece which is provided as a guiding piece (14) and/or the leaf-side pivot bearing (8) is provided on a leaf-side guiding piece which is provided as a guiding piece,
wherein the fixed frame (2) has, for the fixed-frame-side guiding piece, a guiding groove (15) in the form of a fixed-frame-side guiding groove which is associated with the fixed-frame-side guiding piece and which extends with the longitudinal direction thereof in the movement direction (13) of the fixed-frame-side pivot bearing (9) along the fixed frame (2) and/or the leaf (3) has, for the leaf-side guiding piece, a guiding groove in the form of a leaf-side guiding groove which is associated with the leaf-side guiding piece and which extends with the longitudinal direction thereof in the movement direction of the leaf-side pivot bearing along the leaf (3),
wherein the guiding piece (14) can be inserted into the guiding groove (15) in an insertion direction (35) which extends in the longitudinal direction of the associated guiding groove (15) and the guiding piece (14) which is inserted into the guiding groove (15) is guided by means of the guiding groove (15) in the movement direction (13) of the relevant pivot bearing (9) and is engaged over at a side remote from a groove base (18) of the guiding groove (15) by a groove wall (17) of the guiding groove (15) parallel with the groove base (18) and can thereby be supported perpendicularly to the groove base (18) and
further comprising a braking element (30) which is received in a receiving member (29) of the guiding piece (14), which receiving member opens in the direction towards the groove base (18) of the guiding groove (15), and which braking element (30) can be positioned relative to the guiding piece (14) with a positioning movement in a positioning direction of the braking element (30) perpendicularly to the groove base (18) and which can thereby be clamped between the guiding piece (14) and the groove base (18),
wherein a component connection is provided between the guiding piece (14) and the braking element (30) by means of which the braking element (30) is retained on the guiding piece (14) so as to be movable in the positioning direction of the braking element (30).

2. The window or door according to claim 1, wherein the guiding piece (14) and the braking element (30) which is retained by means of the component connection (31) on the guiding piece (14) in a starting state outside the guiding groove (15) form a common cross-section, which in the perpendicular projection in the insertion direction (35) on the cross-section of the guiding groove (15) overhangs the cross-section of the guiding groove (15) by the braking element (30) forming an overhang with respect to the guiding piece (14), and wherein the guiding piece (14) and the braking element (30) which is retained by means of the component connection (31) on the guiding piece (14) can be transferred by means of a movement relative to each other in an assembly state, in which the common cross-section of the guiding piece (14) and the braking element (30) in the perpendicular projection in the insertion direction (35) on the cross-section of the guiding groove (15) is located within the cross-section of the guiding groove (15).

3. The window or door according to claim 2, wherein the braking element (30) is pivotably retained by means of the component connection (31) on the guiding piece (14) so as to be able to be pivoted relative thereto about a pivot axis (33) which extends perpendicularly to the insertion direction (35), wherein the guiding piece (14) and the braking element (30) which is retained by means of the component connection (31) on the guiding piece (14) in the starting state outside the guiding groove (15) form a common cross-section which overhangs the cross-section of the guiding groove (15) by the braking element (30) being pivoted relative to the guiding piece (14) about the pivot axis (33) into a corresponding pivot position and wherein the receiving member (29) provided on the guiding piece (14) for the braking element (30) is arranged in the insertion direction (35) behind the component connection (31) between the guiding piece (14) and the braking element (30).

4. The window or door according to claim 1, wherein the guiding piece (14) is constructed as a composite component and has a metal carrier (23) and a plastics material portion (24) which is connected to the metal carrier (23) and wherein the component connection (31) between the guiding piece (14) and the braking element (30) is provided between the plastics material portion (24) of the guiding piece (14) and the braking element (30).

5. The window or door according to claim 4, wherein the metal carrier (23) of the guiding piece (14) is provided with a positioning device for positioning the braking element (30) relative to the guiding piece (14).

6. The window or door according to claim 5, wherein the metal carrier (23) of the guiding piece (14) has as a positioning device a thread for an adjustment screw (28), by means of which the braking element (30) can be positioned relative to the guiding piece (14).

7. The window or door according to claim 4, wherein the guiding piece (14) which is inserted into the guiding groove (15) is engaged over on the metal carrier (23) of the guiding piece (14) by a groove wall (17) of the guiding groove (15) parallel with the groove base (18).

8. The window or door according to claim 4, wherein the guiding piece (14) which is inserted into the guiding groove (15) is guided on the plastics material portion (24) of the guiding piece (14) in the movement direction (35) of the relevant pivot bearing (9).

9. The window or door according to claim 1, wherein the guiding piece (14) and the braking element (30) are each at least partially constructed as an injection-moulded plastics material component and are injection-moulded onto each other with the component connection (31) being formed.

10. The window or door according to claim 1, wherein the component connection (31) between the guiding piece (14) and the braking element (30) is constructed as a film hinge.

11. The window or door according to claim 1, wherein the component connection (31) between the guiding piece (14) and the braking element (30) can be destroyed by means of a first positioning movement of the braking element (30).
